(19) United States
(12) Patent Application Publication
(10) Pub. No.: US 2003/0126027 A1
(43) Pub. Date: Jul. 3, 2003

(54) Integrated web ring site and method for presenting information

(75) Inventors: Mark F. Nelson, Neenah, WI (US); Meg Posorske, Neenah, WI (US); Mark Nathanson, Neenah, WI (US); Elek Schneider, Neenah, WI (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Kimberly-Clark Worldwide

(21) Appl. No.: 10/038,861

(22) Filed: Dec. 31, 2001

(51) Int. Cl. G06F 17/60

(52) U.S. Cl. 705/26

(57) ABSTRACT

An Integrated Web Ring (IWR) partnership meeting the custom needs of users while providing income to the sponsor/host and strengthening business relationships with partners. The host Web site and the IWR generally are organized according to a theme such as parenting, which can have many thematic topics for which information can be conveyed, as well as related products and services. Community features such as chat rooms, bulletin boards, video conferences, live training sessions, and the like are also generally tied to the theme of the site. Other features include tracking user preferences and generating performance indicators, managing content of the IWR by the host, controlling partners, an IWR navigation tool, an IWR with related product presentation, and an IWR with customizing.

### FIELD OF THE INVENTION

The present invention relates to a system and method for providing information relating to a theme. In particular, this invention relates to an integrated web ring for providing and managing information as well as partners.

### BACKGROUND OF THE INVENTION

Many different business models have been implemented for providing information associated with products and/or services. Typically, these models are based on the information provided by a single source or offered from multiple sources through a single broker who receives commissions for advertising or goods sold. Partnerships between various entities often take the form of a provider-affiliate relationship. Another known approach for establishing relationships between multiple parties, not commonly used by corporations for e-commerce, is a group of related but independent sites which provide links to other sites, often in the form of links to the “next site,” “previous site,” or a “random site.” Such groups typically have disadvantages including a lack of a formal relationship between Web members. As a result, such groups are subject to many forms of abuse, such as a member site not providing appropriate content.

In terms of models directed toward parenting and family needs, several approaches have been used in the past. A variety of Web sites offer content directed to parents. For example, some sites provide their own articles relating to parenting issues. Some sites also “personalize” the Web site for registered users by taking the user to news and other tools aimed at the stage the user is in (e.g., newborn, early pregnancy, etc.). Generally, such sites have the disadvantage of being independent of each other and are stand-alone sites following the traditional model of multiple pages from a single server with occasional links to outside sites, apparently using an affiliate model.

There are similar sites that provide related information for working mothers. Community features can offer the ability to e-mail questions to experts or to post and read messages in forums. Shopping may also be provided in the normal way: links to e-commerce retailers or to specific products are provided, but the shopping links are not directly related to content on the pages.

Some sites offer commercial products, articles, and forums allowing registered users to view a page customized for the ages of their child or children. For example, a page displays the age of the child and then offers information and news suited to the parent. This information may change monthly. For example, a parent of a 7-month-old child may see links to articles about teething and toys for ages 6 to 9 months. The article on toys may also have links to commerce pages on the same site for dolls and other toys suitable for that age. Generally, a shopping cart model is used. Comments from consumers about the products are also provided. Other sites offer some articles, commercial services, opportunities to make free Web pages for babies, and links to baby-related groups. Other sites offer such things as the online “Parenting Institute” (www.pampers.com/en_US/-general/about/aboutindex.jhtml) which serve to promote diapers while offering advice and some content. Some sites feature chat rooms, message boards, articles related to parenting, and products for sale. Groups of sites tend to lack the type of association which would provide a consistent, integrated resource.

There is a need for an integrated group of sites, such as an integrated web ring, which is based on a partnership model for providing information relating to a theme, for providing and managing information within the group, for managing retail partners within the group and for providing information relating to a product and a theme related to the product.

The invention described below addresses one or more of these and other disadvantages and needs.

### SUMMARY OF THE INVENTION

The invention includes a model that combines community, commerce, tools and/or content through an Integrated Web Ring (IWR) partnership that can meet the custom needs of users while providing the potential for increasing brand equity and loyalty to the sponsor and strengthening business relationships with partners. Optionally, the model may also provide a vehicle for generating income to the sponsor and/or the partners. The Integrated Web Ring model is especially well-suited for meeting the needs of parents and for generating commercial success in the business category of parents and parenting, though it can be applied to other commerce areas. The host Web site and the IWR generally are organized according to a theme such as parenting, nutrition, home maintenance, automobiles, sports, entertainment, hobbies such as collecting items or performing amateur magic, and the like, which can have many thematic topics for which information can be conveyed, as well as related products and services. Community features such as chat rooms, bulletin boards, video conferences, live training sessions, and the like are also generally tied to the theme of the site. For example, if the theme is parenting, the IWR may provide information relating to one or more of the following: family life, mothering, fathering, child raising, child development, education, entertainment, family, finance, health, home and garden, shopping, community or other parent information or interests.

In one form, the invention includes an integrated web ring (IWR) site of a host and a plurality of partners for providing and managing information relating to a theme and for tracking access to the information by users. A plurality of partner Web pages relate to the theme are provided by the partners. A host Web site provided by the host is accessible by users and includes a plurality of host Web pages relates to the theme. A link from the host Web site is connected to a selected partner Web page. Tracking software monitors user access to the IWR, to the partner Web pages and to the host Web page and generates performance indicators relating thereto.

In another form, the invention is a method for controlling information relating to a theme which is available on an integrated web ring (IWR) site of a host and a plurality of partners. The method includes the steps of:

providing a plurality of partner Web pages relating to the theme and provided by the partners;

providing a host Web site provided by the host and accessible by users, the host Web site including a plurality of host Web pages relating to the theme;

authorizing the host to select a partner Web page; and providing a link from the host Web site to the selected partner Web page.

In another form, the invention is a method of adding retail partners to an Integrated Web Ring (IWR) that provides a host Web site dedicated to a theme. The IWR site includes partner Web pages, wherein the host Web site is accessible by users, each partner providing at least one partner Web page related to the theme of the IWR site accessible by links from the host Web site, wherein at least some of the partners are retailers offering products whose sale via the IWR site brings commissions to the host. The method includes the steps of:

receiving a request for membership in the IWR from a candidate retail partner having at least one page on its partner Web site related to the theme of the IWR site;

obtaining agreement from the candidate retail partner to abide by a stated policy;

reviewing the Web site of the candidate retail partner to determine if the content does not violate content criteria for IWR partners; and

joining the candidate retail partner to the IWR if the candidate retail partner has met the requirements of obtaining and reviewing steps and by means of a contract identifying payment procedures and responsibilities of both the retail partner and the host.

In another form, the invention is an integrated web ring (IWR) site of a host and a plurality of partners for providing and managing information relating to a theme. A plurality of partner Web pages relate to the theme and provided by the partners. A host Web site provided by the host is accessible by users and includes a plurality of host Web pages relate to the theme. A link from the host Web site is connected to a selected partner Web page. A common navigational tool provided by the host Web site searches and accesses only the host Web pages and the selected partner Web pages.

In another form, the invention is an integrated web ring (IWR) method of a host and a plurality of partners for providing and managing information relating to a theme. The IWR method includes the steps of:

identifying a plurality of partner Web pages relating to the theme and provided by the partners;

providing a host Web site provided by the host and accessible by users, the host Web site including a plurality of host Web pages relating to the theme;

linking the host Web site to a selected partner Web page; and

supplying to users a common navigational tool accessible via the host Web site for searching and accessing only the host Web pages and the selected partner Web page.

In another form, the invention is a method for use by a host of managing partners offering partner Web pages relating to a theme, the method including the steps of:

providing a host Web site provided by the host and accessible by users, the host Web site including a plurality of host Web pages relating to the theme; and establishing a contract between the host and the partners specifying the content of the partner Web pages.

In another form, the invention is a system for providing information relating to a theme and for presenting a product related to the theme. The system includes an integrated web ring (IWR) site including a plurality of partner Web pages relating to the theme and provided by the partners, a host Web site provided by the host and accessible by users, the host Web site including a plurality of host Web pages relating to the theme, and a link from the host Web site to selected partner Web pages. The IWR site is presented as a resource and the host Web site presents the product in association with the IWR as a resource.

In another form, the invention is a method for providing information relating to a theme and for presenting a product related to the theme. The method includes the steps of:

providing an integrated web ring (IWR) site including a plurality of partner Web pages relating to the theme and provided by the partners;

providing a host Web site provided by the host and accessible by users, the host Web site including a plurality of host Web pages relating to the theme; and linking the host Web site to a selected partner Web page wherein the IWR is presented as a resource and wherein the host Web site presents the product in association with the IWR site as a resource.

In another form, the invention is an integrated web ring (IWR) site of a host and a plurality of partners for providing and managing information relating to a theme. The IWR site includes a plurality of partner Web pages relating to the theme and provided by the partners; a host Web site provided by the host and accessible by users, the host Web site including a plurality of host Web pages relating to the theme; a link from the host Web site to a selected partner Web page; and a display of additional information relating to the partners.

In another form, the invention is an integrated web ring (IWR) site of a host and a plurality of partners for providing and managing information relating to a theme. The IWR site includes: a plurality of partner Web pages relating to the theme and provided by the partners; a host Web site provided by the host and accessible by users, the host Web site including a plurality of host Web pages relating to the theme; a link from the host Web site to a selected partner Web page; and a customized newsletter option selectable by each user which periodically delivers to each particular user selecting the option information relating to topics designed by the selected user.

In another form, the invention is an integrated web ring (IWR) site of a host and a plurality of partners for providing and managing information relating to a theme and for tracking access to the information by users. The IWR site includes: a plurality of partner Web pages relating to the theme and provided by the partners; a host Web site provided by the host and accessible by users, the host Web site including a plurality of host Web pages relating to the theme; a link from the host Web site to a selected partner Web page wherein the link is controlled by the host; tracking software for monitoring user access to the IWR site, to the partner Web pages and to the host Web page and generating performance indicators relating to the tracked user access; and a common navigational tool provided by the host Web site for searching and accessing only the host Web pages and the selected partner Web page.

Alternatively, the invention may comprise various other methods and systems. Other features will be in part apparent and in part pointed out hereinafter.

### BRIEF DESCRIPTION OF THE DRAWINGS AND APPENDICES

FIG. 1 is a diagram of one embodiment of the invention illustrating the relationship between partners and host of the Integrated Web Ring (IWR).

FIG. 2 is a functional block diagram of one embodiment of the IWR according to the invention illustrating the functions that the IWR Host manages with respect to the partners.

FIG. 3 is a site map of one embodiment of a web site according to the invention illustrating various locations or pages..

FIG. 4 is a screen shot of one embodiment of the invention.

Appendix A provides an example of how a host Web site can track and analyze user response to partner content for an IWR.

Appendix B is an example of a privacy policy for a host Web site.

Corresponding reference characters indicate corresponding parts throughout the drawings.

### DETAILED DESCRIPTION OF THE INVENTION

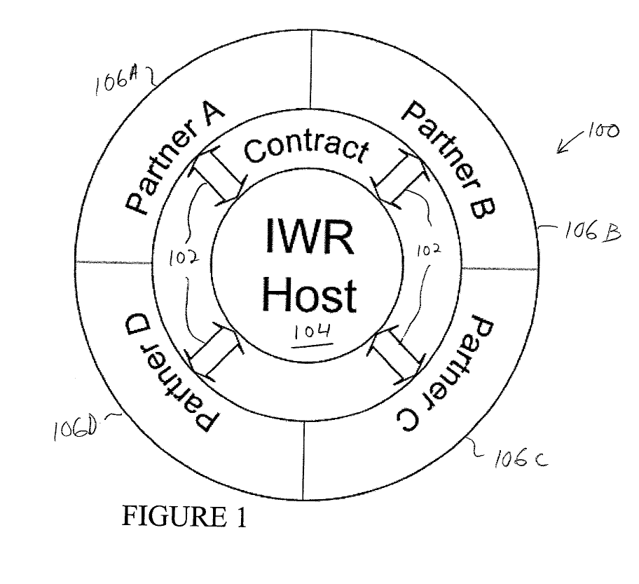

Unlike prior group models or sponsor-affiliate partnerships, the Integrated Web Ring (IWR) 100 according to the invention and as diagrammed in FIG. 1 relies on contractual agreements 102 between the IWR sponsor/host 104 (e.g., Parentstages.com or another host Web site) and the other IWR partners 106A-106D such that the partners provide content, shopping opportunities, tools/tracking and/or community components (chat rooms, message boards) that are used by the host throughout the site to create a rich resource that drives users to the partners in a frames environment that maintains the presence of the host Web site. From a user's perspective, the IWR presents a portal in the form of the host Web site that aggregates the best information, tools and resources on the Web. Preferably, the host Web site houses content, rather than simply linking to other sites and further provides a branded navigation bar which is constant so that users associate their experiences with the site.

As used herein, the term “frames environment” refers to the feature of most modern Web browsers that allows a first Web page from a first site (i.e., having a URL under a first domain name) to display a second Web page from a second external site (e.g., from a page whose URL is under a second domain name different than the first domain name) on a portion of the first Web page, where it is “framed” within the first Web page. This allows a Web page from a first Web site to provide links to external Web sites that allow the user to view pages from the external Web sites without being disconnected from the first Web site; i.e., the Web browser can still display information from the first Web page such as content, logos, the URL, links and buttons outside the framed region displaying an external Web page. In one embodiment, the host Web page can have almost no original host material displayed other than a navigational bar along one side or along the top of the Web page, with the remaining material being in a frame to receive external information.

Alternatively, if the host Web page opts not to use frames, it may use frameless Web pages which can be generated by a server to incorporate external content or other external information from a partner directly into the displayed Web page. For example, in a frameless embodiment, a user selecting a link on a host page to an article by an external partner may be provided with a frameless Web page with a URL from the host domain and with the host's navigational bar at the top, followed by the text and graphics from the external article below the navigational bar.

In one aspect of the invention, the theme of the IWR may be parenting. In this example, the purpose of the host Web site would be to help users reach their full potential as parents by keeping users up-to-date with the latest parenting information. Preferably, the site would anticipate user needs and make it fun and easy for users to find what they need. The well-organized and interactive aspects of an IWR recognize that time is one of the user's biggest challenges and provides the user with options rather than opinions. As a result, the user is empowered to free their children to explore, learn, play and experience life to the fullest.

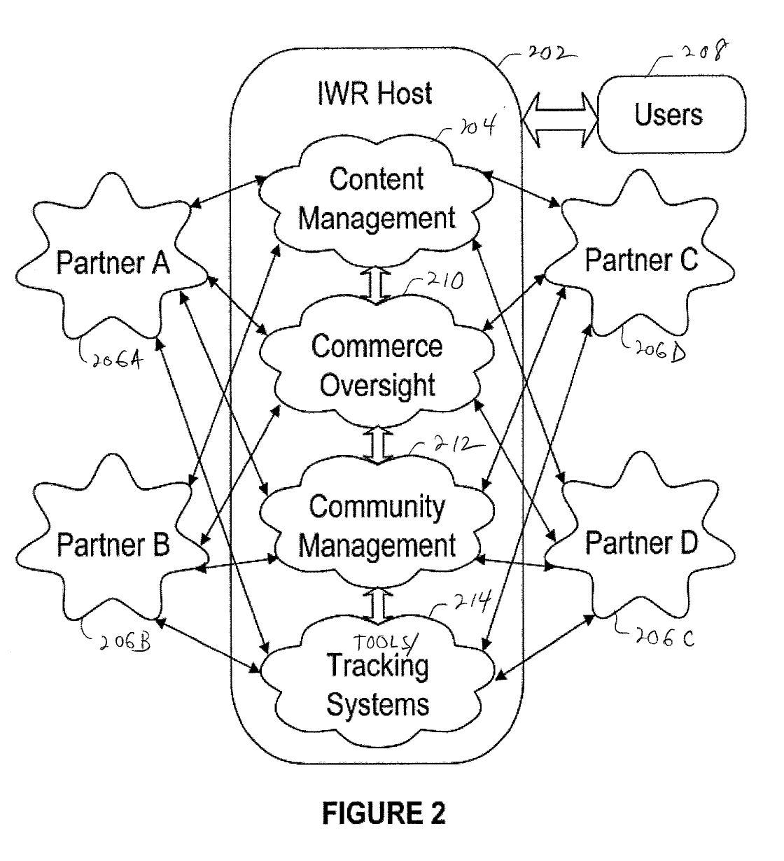

Articles displayed by the IWR host Web site are provided by partners who have a contractual relationship with the IWR host. For example, as shown in FIG. 2, the contractual relationship may permit the IWR Host 202 to provide content management 204 which controls the information provided from the partners 206A-206D via the IWR Host 202 to users 208. Alternatively or in addition, the contractual relationship may permit the IWR Host 202 to provide commerce oversight 210 of the products or services offered by the partners 206A-206D. This oversight may include terms and conditions, subject matter, availability or any other aspect of a product or service offered by a partner.

Alternatively or in addition, the contractual relationship may permit the IWR Host 202 to provide community management 212 of the community related products or services offered by the partners 206A-206D. A community is a group of people who share a common interest, purpose or goal (e.g., the theme of the IWR) and get to know each other over time. Community building on the Web includes different types of interactions which are available in the virtual world including one-to-one (e.g., email a newsletter, article or message to a friend), one-to-many (e.g., “ask an expert”) and/or many-to-many (e.g., discussion boards, polls). Preferably, community-related items are positioned in a community area which is called out on the host Web site and the home page of partner sites. For example, it may appear as a tabbed section in the navigation bar or in the side tool bar of the home page. This placement facilitates cross-pollination of the content presented and community available. Registration of the user should be available on nearly all of the sites requesting information such as name, email, mailing address, details about children, newsletter subscription and subscription to offers. Once registered, returning registrants are recognized.

Preferably, the layout of discussion boards which are part of a community should permit the user to personalize the settings on the boards. Search engine functionality should be configured to make it easier for visitors to find boards on the IWR that interest them. Boards should bring together users with a common interest. If the theme is parenting, boards may bring together mothers and children of the same age, or mothers in the same geographical location. Preferably, boards would have real people as community leaders or moderators. Discussion boards may have a private zone of limited access (e.g., accessible only by family members).

Commenting on presented content of the IWR is also an optional aspect which should be considered. This provides a more focused and controlled way of allowing visitors to communicate with one another. Users may be permitted to make comments below articles or to post information or announcements.

Chats sites or rooms may also be provided as a part of a community. The chats may be scheduled or open chat forums. The chats can be categorized according to rooms or topics and are preferably led or moderated by an expert. Chat sites should allow users to move between rooms, view users present, attach images and in some cases create private rooms. Use of instant messaging may also be integrated as part of the chat sites. The chat rooms may provide search features to find other users.

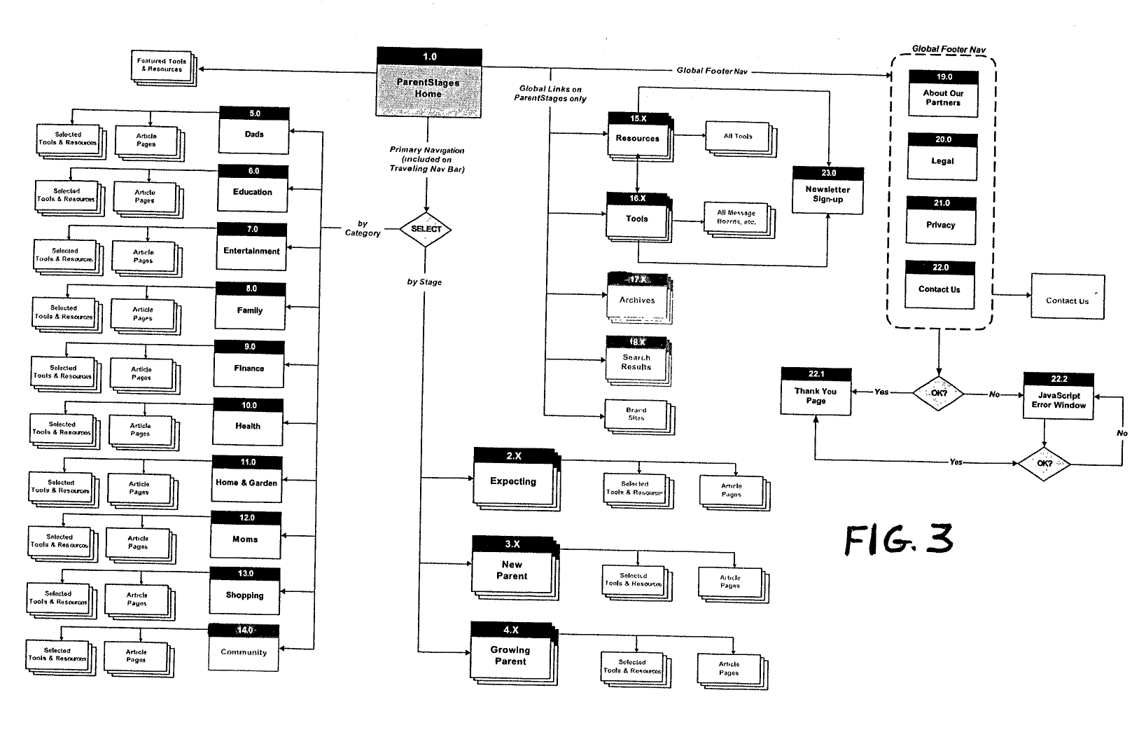

Community can also be enhanced by daily or weekly interactive polls which are featured on the host Web site and/or on the partner sites. Polls may be archived (see location 17.X of FIG. 3) so that users can find polls of interest to them. “Ask the expert” features may also be provided as a submission-based activity or as a live activity. Links to a wide range of experts can also be provided. Other community features include “create your own web page,” photo galleries, online albums and emailing to a friend a link to the host Web site or a partner site. As a result, such sites with such functions create community zones and interweave content and community throughout the IWR.

FIG. 3 is a site map of one preferred embodiment of a web site according to the invention which presents parenting is the theme. As illustrated, the site is titled Parentstages and location 1.0 indicates the home page. From the home page, the user may select a first level of information according to stages such as expecting 2.X, new parent 3.X or growing parent 4.X. Alternatively or in addition, the user may select a first level of information according to categories such as dads (fathering) 5.0, education 6.0, entertainment 7.0, family 8.0, finance 9.0, health 10.0, home and garden 11.0, moms (mothering) 12.0, shopping 13.0 or community 14.0. After this first level selection, the user is directed to selected tools and resources and article pages relating to their selection. In FIG. 3, the diamond shaped boxes indicate decisions or selections which the user makes and the unnumbered boxes without headings indicate tools, resources, pages, message boards or other information which may be provided by partners or other third parties to which the web site of FIG. 3 is linked.

As shown in FIG. 3, the host Web site (and/or the partner sites) may highlight the community elements that exist on tools and resources and place them in a community category as illustrated by location 14.0. Alternatively or in addition, the community elements may be aggregated into a category, stage or other separate collection of inter-related pages (sometimes called a silo) for ease of access. New community elements from partners may be placed in the related silo and/or in the community area as these new elements become available. This aggregation facilitates tracking such as measuring through rate to the community silo and monitoring performance of the individual components. Preferably, community interaction is created over content. In other words, the IWR creates boards and functionality which allow visitors to comment on weekly articles and measures the level of activity on the board/functionality. Other optional aspects of a community include chats using web crossings, creating public discussion boards with functionality which will enable the user to participate in private gated communities, creating a log in process which will recognize users upon return to the site or IWR, and creating multi-sector brand programs which leverage data.

It is contemplated that the collected data may be used in various ways. For example, from the perspective of advertising objectives, the data may be used to set up discussion boards which bring together parents who have children of the same age, to set up multi-sector brands which sponsor relevant boards, or to set up multi-sector banners which appear in emails sent from the boards. From a marketing research objective, the data may be used to set up boards for members to discuss multi-sector brands, to make trial offers sent to loyal discussion board members, or for use by an editor to keep certain theme-related boards active.

Alternatively or in addition, the contractual relationship may permit the IWR Host 202 to provide tools and/or tracking systems 214 which interface with the users 208. Some tools/resources may have a community element. For example, with parenting as a theme, a partner such as Father's World Resources for fathers may provide both a discussion board and an “ask the expert” function. As another example, a partner such as the Learning Network's Homework Helper Tool may have an “ask a question” function. As another example, a partner such as Better Homes and Garden Recipe Search may enable users to submit their own recipes and make comments on recipes posted on its site. Such management, oversight and systems are described in greater detail below.

The contractual relationship may identify levels of payment to the host and partners for purchase of goods by users, for display of articles, and for advertising. The contractual relationship can also govern the way information is displayed, how Web page use is tracked and reported, and so forth. The contractual relationship can identify means to deal with conflicts that occur between partners, such as claims made by one partner that may attack a position taken by another partner, or means to handle differences in e-commerce operation. The terms of the contractual relationship may be constructed to be offered fairly to any partner who meets the conditions identified in a published statement. The terms of the standard agreement between a partner and the IWR host provide a level playing field while limiting the number of partners to a reasonable number through the stipulations of the agreement. For example, the number of partners may be from 2 to 20 or more, more specifically from 4 to 15, more specifically from 5 to 12, or, by way of example, no more than 6, 8, or 10.

For example, the contract between the host and partners may include certain criteria or fundamental requirements which a partner must meet. These may include a minimum involvement and capacity, such as a partner must have the ability to provide at least five articles each week. The contract may specify structure, such as partners must have relevant content channels in place [traffic-driving creative content]. The partner must agree to acceptance of the traveling navigation bar. The partner may be required to utilize proprietary tools which would also be a benefit to the partner. The partner may also be required to present sponsorship opportunities related to the theme.

One useful aspect of the IWR according to the invention is that the IWR provides an essentially neutral or impartial resource that presents information available to users. Through repeated use or because of the primarily objective quality of the information provided, the purchasing behavior of users is indirectly influenced in a positive way toward the sponsor/host and its partners. The sponsor, its partners and their brands become more well-known to the users so that loyalty of the users to the sponsor, its partners and their brands is enhanced. As a result, brand equity of the sponsor and of the partners is increased and may result in increased sales of products and/or services offered by the sponsor and partners under their brands or under other labels or marks associated with the sponsor and partners.

Another alternative or additional useful aspect of the IWR according to the invention is integration between content and commerce. For example, in one embodiment, users can search for articles by any of the partners (or a selected set of partners) on a given topic, and be presented with shopping opportunities from the page that displays content about the topic of interest. In one embodiment, users can search for reviews of a product, such as comments on message boards belonging to a first partner, and simultaneously can be offered shopping opportunities for related products from a second partner or through a second partner's shopping system. The product reviews and links to shopping opportunities can be presented in a single frame formatted by the host, or in two separate frames, or in a frameless page. Likewise, users searching for information on a health issue or other topics can be provided with e-commerce opportunities for related products or services that display on the page with search results and/or on the page or frame displaying selected content. Links can take the user to a customized e-commerce page where products are displayed according to custom criteria previously provided by the user, as discussed in more detail hereafter.

Another useful, alternative aspect of the invention is that the IWR facilitates the sponsor's control of various policies provided by the partners, such as a privacy policy (see location 21.0 of FIG. 3 and Appendix B) and a suitable return policy for protection of customers. The contract between the sponsor and the partners gives the sponsor the leverage to have partners agree that they will adhere to certain policies that are consistent with the IWR and with the host Web site being provided by the sponsor. The contract also gives the sponsor the optional right to control which merchants or other products or services are available on each partner's web site.

### Content Management

In the IWR, content management 204 from the plurality of partners is provided. “Content” as used herein refers to information typically conveyed through text, such as articles, intended to convey understanding to a user regarding a topic related to the theme of the host Web site. Content can also be provided with instructional multimedia means such as videos, slide shows, and the like. Simple links, short descriptions of links (e.g., having a length less than 5 sentences or 50 words), banner ads, promotional graphics, and short sentences are not generally considered “content” as used herein. Content, for example, can be articles of about 100 words or more, e.g., about 200 words, to be read by the user to better understand a topic relating to the theme. The content can be substantially non-commercial in the sense that a particular product is not being explicitly promoted, though recommended methods of using classes of products such as disposable diapers or vitamins could be treated without being considered commercial. In one embodiment, all or substantially all of the articles are partner Web pages made available by the host Web site. Content typically is aimed at providing a benefit for the user through information rather than promoting purchase of a product.

Preferably, the host Web site manages content and the display of content to maintain high standards of credibility and to allow the user to understand the source of information displayed. Content management can be done through the work of a content editor (or a team of editors) of the host Web site. The content editor has access to content provided by the partner Web pages of the various partners. The content editor can regularly select articles deemed to fit the needs and theme of the host Web site, and can provide a link and brief description for the each article which can be directly incorporated into Web pages of the host Web site or into a content database which can be searched by users or used by the host Web site to provide customized content for individual users, based on a user profile or known user preferences. For example, a user known to have a two-year-old child can, upon accessing or logging into the host Web site, automatically be shown a page with links to external articles relevant to the parenting of two-year-olds.

As noted above, the sponsor may store the titles of the articles available through the partners. Alternatively, or in addition, in one embodiment, the content editor may optionally modify the titles of any or all external articles that are used by the host Web site. The modified titles can be entered into a content database or entered on Web pages of the host Web site to better assist users of the host Web site in understanding the content of the external articles and their relevance to the theme of the host Web site or to specific topics on the host Web site. For example, an external medical site in partnership with the IWR may provide an article with the title “Cortisol Tracking with Biosensors” describing the use of biosensors for detecting stress in children. The editor may enter an alternative title to be used when the article is displayed in a frame on the host Web site, such as the title, “Can Stress in Children be Monitored with Saliva-based Testing?” Further, a short description can be entered, as well as a secondary title to be used in links to the article (the links, when activated, can result in display of the content in a frame on the host Web site). Thus, a search by the user on saliva testing, for example, may return a link entitled, “Saliva Sensor for Child Stress,” followed by a short sentence that can be simply text, not hypertext, such as “An article from ChildMedLiterature.com about a new biosensor system for monitoring stress in children at daycare centers.” When the link is activated, a frame can display the content of the original external article, but wherein the original title has been replaced with the new title provided by the content editor.

In another embodiment, a plurality of alternative titles and short descriptors can be entered for each article to provide an index to allow the displayed title and short descriptor to better correspond with the host Web page on which they are displayed, including to better correspond with the inferred needs or interest of an individual user. For example, the host Web site may have topical areas of “Advanced Technology” and “Working Mothers.” For users viewing information in the “Advanced Technology” area, the external article may be given a link entitled “Cortisol Enzyme Testing” and an article title of “Stress Biosensor Using Saliva-based Analyte.” The latter title could be displayed with the content as if it were the original title of the article when the article is viewed in a frame on the host Web site (or, alternatively, as embedded text within a Web page placed on or generated by the host Web site). On the other hand, users of the “Working Mothers” area of the host Web site could be provided with a link entitled “Monitoring Stress in Your Child While You're Away” and a display title of “Can Biological Stress Monitors Give Mom Peace of Mind?”

The content editor enters information in the content database to indicate defaults for the article title, link text, and short descriptor, plus alternatives for specific topic areas or for users matching certain criteria. For example, a record may indicate that users who are working mothers could be provided with the same information used in displays for the Working Mothers area. In general, a content database provides multiple choices for link text, article title, and short descriptors of the article or other content, wherein the selections that are actually displayed can be responsive to the topic area in which they are displayed, to a user profile stored in a cookie or other means, to recent searches done by the user (see location 18.X of FIG. 3), to the nature of the site from which the user came prior to entering the host Web site, to the nature of any recent purchases, and so forth.

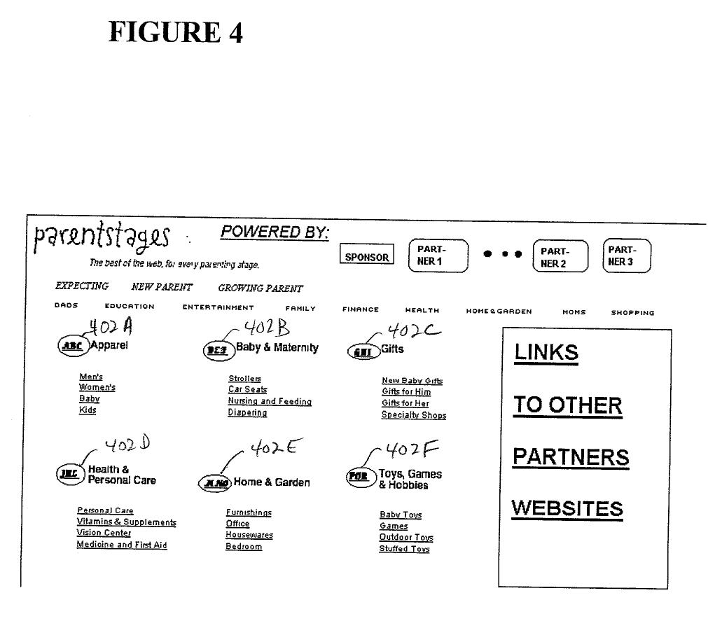

In one embodiment, any link on the host Web site to content provided from a partner is further provided with a source identifier showing which partner is the source. For example, the source identifier can be a small logo 402A-402F as shown in FIG. 4 or other easily recognized image indicating the source, wherein the image can be static or be hyperlinked. The source identified can also be text, either plain text or hypertext with a link to the partner, to information about the partner, or to the article or other services offered by the partner. The presence of a source identifier enhances the credibility of the content and allows the user to immediately understand its source, even though it is displayed in an environment controlled by the host.

In some embodiments, content offered through the host can be considered to be “live content” or archived. As used herein, “live content” refers to content which is viewed as recent according to criteria established by the host, such as content no older than a fixed period of time such as one week, two weeks, four weeks, six weeks, or three months. Live content is generally actively promoted, such as by displaying it on current main pages for relevant topic areas. Archived content, on the other hand, may require entering an archive area to access the content, or may require doing a search before the archived content is retrieved.

New partners may be provided with a web site development guide which assists them in developing web sites that are consistent with and compatible to the host Web site. The guide may also specify aspects which are required by the contractual arrangements. For example, the contract and/or the guide may address the following: the tonality of all communications; online advertising that reinforces the host Web site brand message; scannability of the content including one idea per paragraph, use of simple sentences and emphasis of key points; use of bullet points, headlines and subheads; graphic standards relating to logos, minimum clear zones, minimum size, use of the host's brand mark and colors therefor; design elements such as screen layout, home page template, additional page templates such as secondary level pages and third level pages; use of color which is consistent with online and offline media including logo color, primary color palette, secondary color palette, navigation and homepage background, background colors and sublevels; typography; body copy; alignment and paragraph properties; photography including site placement, people usage and sources of photos; and accessibility such as design for multiple browsers and multiple platform compatibility, minimizing of download times and/or file sizes, avoiding non-standard technologies and plug-ins that may prevent users from receiving content, and avoiding frames or sublevel pages that complicate navigation and measurement.

### Tracking Systems

For many preferred embodiments, a valuable aspect of the IWR is a tracking feature which allows the structure of the IWR to be regularly revised and updated based on performance indicators for partners, topics, and topics within partners. In this system, any off-the-shelf or custom software can be part of the IWR according to the invention to track the number of times an article or other content source is used, both in terms of overall usage rates and optionally in terms of usage from a particular host page or in the context of a topic area on the host Web site. Software also tracks how extensively other services are used, such as bulletin boards, shopping services, games, multimedia offerings, and so forth.

In one preferred embodiment, frequency-of-use statistics are used to show how often content from a particular partner is used, as well as how often content from a particular category within the partner's Web site is used, to allow the IWR host administrator or content editor to focus on partners and partner categories that are most relevant as judged by usage rate from visitors to the host Web site.

For example, an external partner may have five topical categories whose content is used on the host Web site. Two or more articles from each category may be used as content for the IWR. Monthly or weekly use rates may indicate that articles from the partner in two of the five categories are accessed by no more than 1% of IWR visitors who are presented with a link to those article, whereas the remaining three categories generate access rates of 4% or higher from visitors to the host Web site presented with links to those articles. In light of the relatively lower level of IWR user interest in the content from two of the five categories, the content editor may choose to no longer include the low-performing categories from the external partner for consideration as content presented through the IWR. If the external partner as a whole generates relatively little interest, as measured by total number of accesses or percentage of presented links accessed or other relevant measures, the external partner may be dropped from the IWR.

In one preferred embodiment, the IWR model includes systematic review of user access of external content to allow the content editor or system administrator to drop low performing categories within partner sites from use by IWR, or to drop entire partners from the IWR when user access of partner services falls below an acceptable threshold.

Regular updating of the IWR and the content sources accessible via the IWR can occur weekly, monthly, or at any reasonable time period. Appendix A provides an example of how a host Web site can track and analyze user response to partner content for an IWR.

### Customization of the Host Web Site

In one preferred embodiment, the page or frame used to display an article from a partner will be modified when viewed via the host IWR to display additional related information from other partners, including e-commerce opportunities. The modification can be done to customize the displayed page or frame for the individual user.

Users going directly to the partner's page without going through the host IWR may not see the additional information from other partners. The additional or modified content can be guided by personal information provided by the consumer during registration or by a history of the user's activities on the host IWR site or on any partner's site. For example, for a user known to make purchases of wet wipes, a search about articles on cleaning might be displayed with a wet wipes advertisement from a partner site, or with a link to a shopping page about wet wipes, with offers from various partners displayed in accordance with user preference information. As a further example, if the user is a parent who regularly seeks out entertainment options among the partner sites, a search on articles about diapers might return a page that not only lists articles about diapers, but displays choices for interactive games associated with diapers.

Many optional features are contemplated. For example, product labeling may be used to advertise the host Web site. Partners may receive benefits from the host by providing the logo and URL for the IWR on at least some products. Products purchased from a partner while under the IWR host may be shipped with packaging, labeling, or literature promoting the IWR or the host. This may be a requirement or an option with incentives provided by the host.

Another optional feature is customization of displayed information based on a user profile or “cookie” created by the host in response to personal information entered while registering. Thus, the shopping experience on the IWR can be customized. For example, either during registration or at any later stage the customer can define what factors are important in searching for a product. The customer may wish to sort product searches by price to ensure that the lowest prices are displayed first. The customer may also wish to exclude some vendors or some partners from a product search. The customer may wish to only search for products offered by merchants with a flexible return policy, with low shipping costs, or with rapid delivery capabilities.

In one embodiment, the customer can prioritize which features are most important. For example, the customer may prefer goods provided with a return policy, but may be willing to forego a return policy if delivery time is rapid or price is sufficiently low. Customization can be achieved by rating each feature, for example, as mandatory, high priority, low priority, unnecessary, or not wanted. Numerical values can also be assigned to indicate relative priority of any feature. The customer provides information about priorities and desires, which can be recorded in a “cookie” to guide the structure of subsequently displayed pages or information on those pages. For example, all subsequent searches for products may only display those provided with a return policy, sorted by price, and excluding products offered through a certain retailer.

Displayed content can also be affected by personal information about the user. For example, a parent of small children may first be presented with articles suited for that stage in parenting as the parent views various subject areas. The order of displayed articles may be sorted according to user preferences, or certain content may be screened altogether.

Personal information can also be obtained by tracking consumer activity on the site, even if a consumer does not register, though all tracking is preferably done under standard conventions and rules for maintaining privacy. Purchase history, browsing habits, apparent preferences for shopping and article selection, time of day the Web site is visited, and so forth can be used to identify characteristics of the user that, in turn, can be used to enhance the user's experience with the site by providing more relevant information or favorite entertainment features or by promoting products or vendors the customer appears to like best.

Appendix B is an example of a privacy policy for a host Web site.

### Customized Newsletter

In another preferred embodiment, the user can subscribe to a newsletter (see location 23.0 of FIG. 3) preferably delivered by email which provides customized information of particular interest to the user. The sponsor provides a customized newsletter option selectable by each user which periodically delivers to each particular user selecting the option information relating to topics designated by the user. For example, the user would indicate an interest in such a newsletter and would select topics of interest. Periodically, the sponsor would collect recent information by topic to be part of a newsletter and each user would be sent the topical information that corresponds to their previously indicated interests. The user would be permitted to modify their selected interests at any time or otherwise customize the content of the newsletters provided to the user. For example, users may select how often they want to receive the newsletter (weekly, monthly, etc.)

### Other Features

The IWR provides an archive where past articles and other services can be retrieved. Archived content may be searchable or retrievably organized according to original date, source of origin, theme, and so forth.

The basic IWR can be further enhanced in many optional ways. For example, multiple languages may be supported, with the host Web site and partners providing content in multiple languages or providing translation services. There could be an option of searching for terms in pages across multiple languages, wherein the search terms are automatically translated and sought in source documents, and wherein the found content may optionally be automatically translated into the user's language. Community features can also be enhanced with any suitable resource, such as live video conferencing or real time broadcast of lectures or training sessions on health or other issues. The benefits of community features include the ability to attract users to the host Web site, the ability to give users a reason to return to the host Web site, and the ability to capture user data.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above systems and methods without departing from the scope of the invention, it is intended that all matter contained in the above description and shown in the accompanying drawings shall be interpreted as illustrative and not in a limiting sense.

[image]

[image]

[image]

[image]

[image]

What is claimed is:

1. An integrated web ring (IWR) site of a host and a plurality of partners for providing and managing information relating to a theme and for tracking access to the information by users, the IWR site comprising:
a plurality of partner Web pages relating to the theme and provided by the partners;
a host Web site provided by the host and accessible by users, said host Web site including a plurality of host Web pages relating to the theme;
a link from the host Web site to a selected partner Web page; and
tracking software for monitoring user access to the IWR site, to the selected partner Web page and to the host Web pages and generating performance indicators relating thereto

2. A method for controlling information relating to a theme, the information being available on an integrated web ring (IWR) of a host and a plurality of partners, the method comprising the steps of:
providing a plurality of partner Web pages and provided by the partners relating to the theme;
providing a host Web site provided by the host and accessible by users, said host Web site including a plurality of host Web pages relating to the theme;
authorizing the host to select a partner Web page; and
providing a link from the host Web site to the selected partner Web page.

3. The method of claim 2 further comprising the step of allowing the host to modify a title of the partner Web page as it appears on the host Web site.

4. The method of claim 2 further comprising the step of allowing the host to index the partner Web page by assigning a key word associated with the partner Web page.

5. A method of adding retail partners to an Integrated Web Ring (IWR) site that provides a host Web site dedicated to a theme, the IWR site comprising partner Web pages, wherein the host Web site is accessible by users, each partner providing at least one partner Web page related to the theme of the IWR site accessible by links from the host Web site, wherein at least some of the partners are retailers offering products whose sale via the IWR site brings commissions to the host; the method comprising the steps of:
receiving a request for membership in the IWR site from a candidate retail partner having at least one page on its partner Web site related to the theme of the IWR site;
obtaining agreement from the candidate retail partner to abide by a stated policy;
reviewing the Web site of the candidate retail partner to determine if the content does not violate content criteria for IWR partners; and
joining the candidate retail partner to the IWR site if the candidate retail partner has met the requirements of obtaining and reviewing steps and by means of a contract identifying payment procedures and responsibilities of both the retail partner and the host.

6. The method of claim 5 wherein the stated policy of the obtaining step includes the candidate retail partner agreeing to abide by a stated privacy policy, to abide by a suitable return policy for the protection of customers, and to provide searchable product information that can be screened or sorted by the host during a user product search according to predetermined user preferences relative to at least one of price and manufacturer identity.

7. An integrated web ring (IWR) site of a host and a plurality of partners for providing and managing information relating to a theme, the IWR site comprising:
a plurality of partner Web pages relating to the theme and provided by the partners;
a host Web site provided by the host and accessible by users, said host Web site including a plurality of host Web pages relating to the theme;
a link from the host Web site to a selected partner Web page; and
a common navigational tool provided by the host Web site for searching and accessing only the host Web pages and the selected partner Web page.

8. The IWR site of claim 7 wherein the selected partner Web page comprises content relating to the theme and/or product purchase opportunities wherein the product relates to the theme and/or a community component relating to the theme.

9. The IWR site of claim 7 wherein the theme is parenting and wherein the information relates to one or more of the following: family, mothering, fathering, child raising, child development, education, entertainment, family, finance, health, home and garden, shopping, community or other parent information or interests.

10. The IWR site of claim 7 wherein the link on the host Web site to the selected partner Web page is displayed with a brief description of a content of the selected partner Web page and a visible indication of an identity of the partner providing the partner Web page, wherein at least some of the partners are retailers providing product Web pages for purchasing products related to the theme, the pages for purchasing products being accessible by links available on the partner Web pages, and wherein the purchase of a product via the ring results in a fee paid to the host and/or a fee paid to any partner that guided the user to the product Web page used for purchasing the product.

11. The IWR site of claim 7 wherein the link on the host Web site to the selected partner Web page is displayed with a partner ad, and wherein the displayed ad results in a fee paid to the host.

12. The IWR site of claim 7 wherein the link on the host Web site to the selected partner Web page is displayed with an article display, and wherein the displayed article results in a fee paid to the host.

13. The IWR site of claim 7 wherein the link includes a source identifier identifying the partner providing the partner Web page to which the link directs the user.

14. An integrated web ring (IWR) method of a host and a plurality of partners for providing and managing information relating to a theme, the IWR method comprising the steps of:
identifying a plurality of partner Web pages relating to the theme and provided by the partners;
providing a host Web site provided by the host and accessible by users, said host Web page including a plurality of host Web pages relating to the theme;
linking the host Web site to a selected partner Web page; and
supplying to users a common navigational tool accessible via the host Web site for searching and accessing only the host Web pages and the selected partner Web page.

15. A method for use by a host of managing partners offering partner Web pages relating to a theme, the method comprising the steps of:
providing a host Web site provided by the host and accessible by users, said host Web site including a plurality of host Web pages relating to the theme; and
establishing a contract between the host and the partners specifying a content of the partner Web pages.

16. A system for providing information relating to a theme and for a presenting product related to the theme, said system comprising:
an integrated web ring (IWR) site including a plurality of partner Web pages relating to the theme and provided by the partners, a host Web site provided by the host and accessible by users, said host Web site including a plurality of host Web pages relating to the theme, and links from the host Web site to selected partner Web pages; wherein the IWR site is presented as a resource and wherein the host Web site presents the product in association with the IWR site.

17. A method for providing information relating to a theme and for a presenting product related to the theme, said method comprising the steps of:
providing an integrated web ring (IWR) site including a plurality of partner Web pages relating to the theme and provided by the partners;
providing a host Web site provided by the host and accessible by users, said host Web site including a plurality of host Web pages relating to the theme; and
linking the host Web site to selected partner Web pages wherein the IWR site is presented as a resource and wherein the host Web site presents the product in association with the IWR site.

18. An integrated web ring (IWR) site of a host and a plurality of partners for providing and managing information relating to a theme, the IWR site comprising:
a plurality of partner Web pages relating to the theme and provided by the partners;
a host Web site provided by the host and accessible by users, said host Web site including a plurality of host Web pages relating to the theme;
a link from the host Web site to a selected partner Web page; and
a display of additional information relating to the partners.

19. An integrated web ring (IWR) site of a host and a plurality of partners for providing and managing information relating to a theme, the IWR site comprising:
a plurality of partner Web pages relating to the theme and provided by the partners;
a host Web site provided by the host and accessible by users, said host Web site including a plurality of host Web pages relating to the theme;
a link from the host Web site to a selected partner Web page; and
a customized newsletter option selectable by each user which periodically delivers to each particular user selecting the option information relating to topics designated by the selected user.

20. An integrated web ring (IWR) site of a host and a plurality of partners for providing and managing information relating to a theme and for tracking access to the information by users, the IWR site comprising:
a plurality of partner Web pages relating to the theme and provided by the partners;
a host Web site provided by the host and accessible by users, said host Web site including a plurality of host Web pages relating to the theme;
a link from the host Web site to a selected partner Web page wherein the link is controlled by the host;
tracking software for monitoring user access to the IWR site, to the selected partner Web page and to the host Web pages and generating performance indicators relating to the tracked user access; and
a common navigational tool provided by the host Web site for searching and accessing only the host Web pages and the selected partner Web page.
